(19) United States
(12) Patent Application Publication
(10) Pub. No.: US 2013/0287876 A1
(43) Pub. Date: Oct. 31, 2013

(54) PERFORATED PLATE

(71) Applicant: Automatik Plastics Machinery Gmbh, Grossostheim (DE)

(72) Inventors: Reinhardt-Karsten Murb, Aschaffenburg (DE); Hans-Walter Hefner, Mombris (DE)

(21) Appl. No.: 13/925,963

(22) Filed: Jun. 25, 2013

Related U.S. Application Data
(63) Continuation of application No. PCT/EP2011/005853, filed on Nov. 21, 2011.

(30) Foreign Application Priority Data
Jan. 11, 2011 (DE) 102011008257.3
Nov. 21, 2011 (EP) PCT/EP2011/005853

(51) Int. Cl. B26D 1/12

(52) U.S. Cl. CPC B26D 1/125
USPC 425/67

(57) ABSTRACT

A perforated plate of a granulating device for thermoplastic plastic material, having nozzle openings, and wherein at least one side of the perforated plate has a functional layer in at least one region. The functional layer is thermally insulating as compared to the base material of the perforated plate, and is more abrasion-resistant than the base material of the perforated plate, and consists of an enamel coating.

### CROSS REFERENCE TO RELATED APPLICATIONS

The present application is a Continuation Application and claims priority to and the benefit of co-pending International Patent Application No. PCT/EP2011/005853, filed on Nov. 21, 2011, entitled “PERFORATED PLATE,” which claims priority to DE Application No. 102011008257.3, which was filed on Jan. 11, 2011. These references are incorporated in their entirety herein.

### FIELD

The present embodiments generally relate to a perforated plate of a granulating device for thermoplastic plastic material having nozzle openings.

### BACKGROUND

In general, granulating devices are frequently used for granulating thermoplastic materials such as polyethylene or polypropylene, in which the molten plastic material is pressed through nozzle openings of a perforated plate into a coolant, for example water, and is severed there by a cutter arrangement whose at least one blade passes over the nozzle openings of the perforated plate so that pellets are produced. Corresponding devices that, for example, execute methods for underwater granulation, are known as underwater granulators, for example under the product name SPHERO® from Automatik Plastics Machinery GmbH. In such granulating devices, relatively high wear of the perforated plate takes place, especially in the region of the nozzle openings, on account of the high forces with which the cutter arrangement is driven on the perforated plate. In addition, high thermal stresses occur in the region of the perforated plate because of the direct contact of the perforated plate with the hot, molten plastic material and with the coolant and the other components of the granulating device. Moreover, during the process of designing systems with die heads for underwater hot die-face pelletizing, for example, the problem arises that contact with the coolant (e.g., process water) severely cools the die head, and hence the melt passages. Consequently, good thermal insulation and also a high degree of wear protection are desirable in perforated plates for granulating devices in order, firstly, to ensure reliable operation of a corresponding granulating device and, secondly, to allow the service life to be as long as possible.

Accordingly, a need exists for a perforated plate that makes it possible to provide optimized thermal insulation at the same time as high wear resistance by simple design means and in the most economical manner possible.

Another need exists for a perforated plate that has the longest possible service life.

The present embodiments meet these needs.

### BRIEF DESCRIPTION OF THE DRAWINGS

The detailed description will be better understood in conjunction with the accompanying drawings as follows:

FIG. 1 depicts a schematic sectional view of an enlarged cutaway portion of a perforated plate with a functional layer.

FIG. 2 depicts a schematic sectional view of the perforated plate according to the invention.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments generally relate to a perforated plate of a granulating device for thermoplastic plastic material having nozzle openings.

The perforated plate can have nozzle openings. A functional layer can be located on at least one side of the perforated plate. For example, the functional layer can be located in at least one region of the nozzle openings that is passed over by a blade during operation of the device.

The functional layer can be thermally insulating as compared to the base material of the perforated plate and more abrasion-resistant than the base material of the perforated plate. The functional layer can be made from or have an enamel coating. The enamel coating can include an amorphous, SiO2-based substance with additives to influence melting behavior, material strength, adhesion, abrasion resistance, and thermal shock resistance as an insulating and wear protection layer. In one or more embodiments, the perforated plate can have the functional layer over at least one entire side.

A perforated plate of this nature can offer a homogeneous thermal insulating layer at the same time as wear resistance in the region of the functional layer while avoiding possible damage to the coating due to different thermal expansion coefficients of the perforated plate. A first application of the perforated plate resides in the enameling of perforated plates for strand pelletizers. As a result of the enameling, heat loss due to aspiration cooling or air passing by is reduced, sensitivity to local cooling produced by spray water is reduced, and operating performance is improved. Additional applications reside in the area of underwater and air-cooled hot die-face pelletizing, where the thermal protection layer can also be used as a wear protection layer.

The enamel coating reduces the overall heat transfer from the region of the nozzle openings (e.g., arrangement as nozzle ring) such that it is possible to operate at far lower feed pressures of, for example, an extruder or a melt pump, than are currently customary in the industry without the risk of the thermoplastic plastic material or polymer solidifying in the die head.

The use of nonmetallic materials in combination with metallic materials in the region of the perforated plate usually entails the problem that metallic and nonmetallic materials have very different coefficients of thermal expansion. The temperature range normally required for operation and cleaning of the device is approximately 450 degrees Celsius in this context. Consequently, internal stresses can easily arise with integrally joined material pairs that can stress the materials beyond their maximum strength and thereby result in destruction.

However, the distinctive feature and the advantage of the enamel coating with enamel as a special glass, reside in the fact that the enamel coating can produce a micro-crack structure under stress that permits elastic deformation beyond that of solid material. In addition, the formation of a microporosity is made possible that reduces thermal conductivity and also reduces crack propagation. However, the use of enamel also allows certain manufacturing advantages: concave surfaces can be filled in, and the wear protection layer is integrally joined to the surface during the course of manufacture. As a result, the nozzle openings can be provided as capillary nozzles with conical walls. The wall thickness here should be kept sufficiently thick overall that the capillary tube neither tears open along the tube axis due to the prevailing pressure, nor detaches in the circumferential direction as a result of the shear stress transmitted to the wall in the portion remaining to the outlet by friction in the course of pressure drop. Both forces decrease toward the outlet of the nozzle opening, so that the optimal wall thickness approaches zero towards the outlet of a thusly designed nozzle opening from a minimum wall thickness determined by mechanical considerations in the vicinity of the start of the capillary.

The enamel coating can have a thermal conductivity that is a factor of 25 lower than that of structural and stainless steels. In embodiments of the perforated plate, the functional layer can have a layer thickness ranging from 5.0 millimeters to 10.0 millimeters.

In another embodiment of the perforated plate, the functional layer is microporous, as already described above, and can have a pore size of less than 10 micrometers.

Usefully, the functional layer is arranged on the surface of the perforated plate according to the invention, preferably on the entire surface, of the plate out of which the thermoplastic plastic material emerges from the nozzle openings.

In another embodiment of the perforated plate, the functional layer can be constructed in multilayered form, from enamel materials with different compositions.

The nozzle openings can each be faced with capillary tubes that also cut through the enamel functional layer. The capillary tubes cutting through the functional layer (i.e., the insulating and wear protection layer) can have any desired internal cross-sectional shape, but, in a non-limiting embodiment, the capillary tubes can have a cylindrical cross-sectional shape, and can have a wall thickness that decreases steadily towards the nozzle outlet. The capillary tubes can be shaped such that a truncated cone shape is produced.

For compensation of possible edge chipping in the region of the nozzle openings, the outlets of the melt outlet passages can be provided with appropriately thin-walled, inserted tubules, which can be tightly attached there by means of laser welding or soldering, for example. The tubules initially jut out from the surface. Then the side of the perforated plate facing the process water is enameled with the thickest possible layering. The tubules permit a coating that reaches to the outlets. In a next step, the surface of the enamel is ground down together with the tubules, and in doing so is equalized to a certain layer thickness.

According to an embodiment of the perforated plate, the functional layer can have a hardness ranging from 500 HV to 700 HV. In one or more embodiments, the functional layer can have a hardness of 600 HV.

The functional layer can have a thermal conductivity coefficient ranging from 1 W/mK to 2 W/mK.

The functional layer can have a coefficient of thermal expansion that corresponds to that of the pure base material of the perforated plate or at least that only deviates therefrom in the range of ±10 percent. This improves still further the thermal expansion properties of the perforated plate thus designed in accordance with the invention, since a greatest possible homogeneity of the thermal expansion coefficient can be provided over the entire perforated plate including the functional layer.

With regard to the most homogeneous and matched possible coefficient of thermal expansion of the perforated plate, the base material of the perforated plate can be a metal or a metal alloy, such as steel or a steel alloy.

The invention is explained in detail below with reference to the attached drawings by way of example.

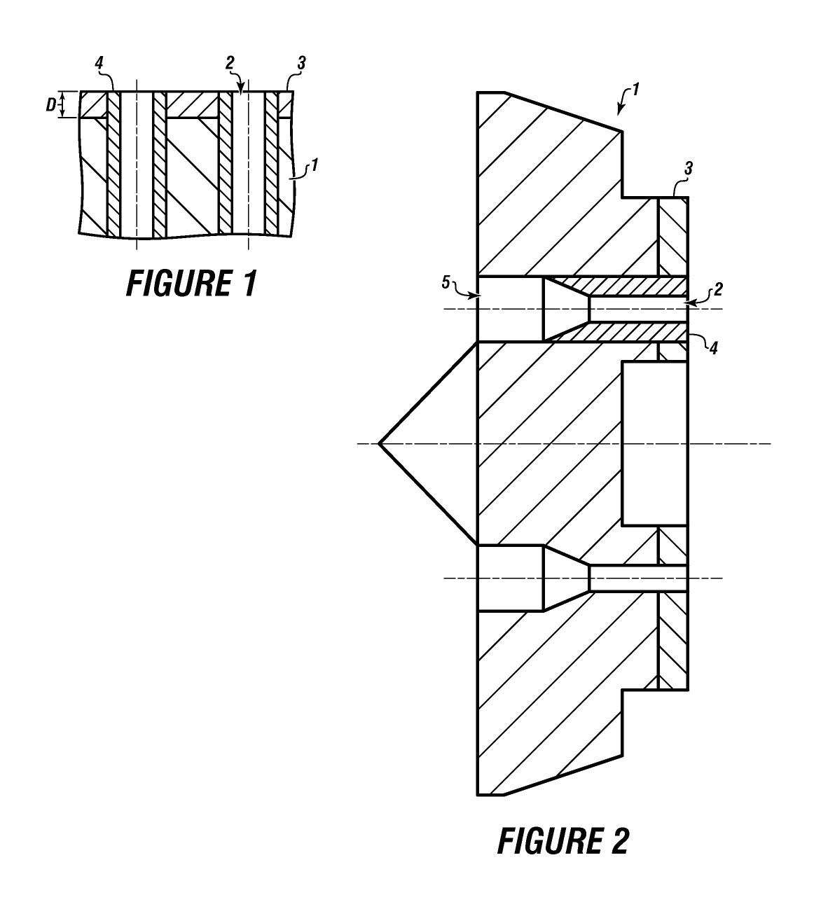

FIG. 1 depicts a schematic sectional view of an enlarged cutaway portion of a perforated plate with a functional layer.

The perforated plate 1 can have a functional layer 3. The functional layer 3 can be thermally insulating as compared to the base material of the perforated plate 1 and more abrasion-resistant than the base material of the perforated plate 1. The functional layer can consist of an enamel coating with a layer thickness (d) of, for example, 5.00 millimeters. The nozzle openings 2 can each be faced with capillary tubes 4 that also cut through the functional layer 3.

FIG. 2 depicts a schematic sectional view of the perforated plate according to the invention.

The perforated plate 1 with the functional layer 3 made of an enamel coating can be mounted on an outlet region of, e.g., an extruder or melt pump of a granulating device (not shown in FIG. 2). The perforated plate 1 can be single-piece in implementation, for example made of one piece. The molten thermoplastic plastic material can be supplied through melt passages 5 to the nozzle openings 2 of the perforated plate 1, and the thermoplastic plastic material can exit the nozzle openings 2. A cutter arrangement (likewise not shown in FIG. 2), can sever the thermoplastic plastic material after it exits the nozzles openings 2, producing pellets from the thermoplastic plastic material.

The functional layer 3 can be provided in only one region of the perforated plate 1, located, for example, in the region of the nozzle openings 2, since wear protection, in particular, is advantageous and desirable primarily in that location because of the blades of the cutter arrangement rotating there. In contrast, FIG. 2 shows an embodiment in which an entire side or surface of the perforated plate 1 is provided with the functional layer 3, which optimizes the thermal conductivity properties, in particular, to be correspondingly homogeneous over the entire side of the thusly designed perforated plate 1 in accordance with the invention. The top nozzle opening of the nozzle openings 2, shown in cross-section in FIG. 2, is shown faced with a capillary tube 4, which also cuts through the functional layer 3.

An arrangement such as is shown in FIG. 2 can be used in an underwater granulator, for example.

While these embodiments have been described with emphasis on the embodiments, it should be understood that within the scope of the appended claims, the embodiments might be practiced other than as specifically described herein.

What is claimed is:

1. A perforated plate of a granulating device for thermoplastic plastic material, having nozzle openings, wherein at least one side of the perforated plate has a functional layer in at least one region, wherein the functional layer is thermally insulating as compared to a base material of the perforated plate, and is more abrasion-resistant than the base material of the perforated plate, and comprises an enamel coating.

2. The perforated plate according to claim 1, wherein the functional layer has a layer thickness ranging from 5.0 millimeters to 10.0 millimeters.

3. The perforated plate according to claim 2, wherein the functional layer is microporous.

4. The perforated plate according to claim 2, wherein the functional layer is arranged on a surface of the perforated plate, wherein a thermoplastic plastic material emerges from the nozzle openings of the perforated plate.

5. The perforated plate according claim 4, wherein the functional layer is constructed in multilayered form, and wherein the functional layer is made from enamel materials with different compositions.

6. The perforated plate according to claim 5, wherein the functional layer is arranged on the surface of the perforated plate, wherein the thermoplastic plastic material emerges from the nozzle openings of the perforated plate.

7. The perforated plate according to claim 6, wherein the nozzle openings are each faced with capillary tubes that also cut through the functional layer.

8. The perforated plate according to claim 1, wherein the nozzle openings are each faced with capillary tubes that also cut through the functional layer.

9. The perforated plate according claim 1, wherein the functional layer is constructed in multilayered form, and wherein the functional layer is made from enamel materials with different compositions.

10. The perforated plate according to claim 9, wherein the functional layer has a hardness ranging from 500 HV to 700 HV.

11. The perforated plate according to claim 10, wherein the functional layer has a thermal conductivity coefficient ranging from 1 W/mK to 2 W/mK.

12. The perforated plate according to claim 11, wherein the functional layer has a coefficient of thermal expansion that corresponds to that of the pure base material of the perforated plate or at least that only deviates therefrom in the range of ±10 percent.

13. The perforated plate according to claim 1, wherein the functional layer has a hardness ranging from 500 HV to 700 HV.

14. The perforated plate according to claim 1, wherein the functional layer has a thermal conductivity coefficient ranging from 1 W/mK to 2 W/mK.

15. The perforated plate according to claim 1, wherein the functional layer has a coefficient of thermal expansion that corresponds to that of the pure base material of the perforated plate or at least that only deviates therefrom in the range of ±10 percent.

16. The perforated plate according to claim 1, wherein the base material of the perforated plate is a metal or a metal alloy.

17. The perforated plate according to claim 1, wherein the functional layer is arranged on the surface of the perforated plate, wherein the thermoplastic plastic material emerges from the nozzle openings of the perforated plate.

18. The perforated plate according to claim 1, wherein the nozzle openings are each faced with capillary tubes that also cut through the functional layer.

19. The perforated plate according to claim 1, wherein the functional layer is microporous.

20. The perforated plate according to claim 19, wherein the functional layer is arranged on the surface of the perforated plate, wherein the thermoplastic plastic material emerges from the nozzle openings of the perforated plate.
